(19) United States
(12) Patent Application Publication
(10) Pub. No.: US 2025/0260219 A1
(43) Pub. Date: Aug. 14, 2025

(54) TRANSMISSION LINE SPACER CLAMP

(71) Applicant: Hubbell Incorporated, Shelton, CT (US)

(72) Inventor: Nnamdi Gabriel Okafor, Birmingham, AL (US)

(21) Appl. No.: 19/051,622

(22) Filed: Feb. 12, 2025

Related U.S. Application Data
(60) Provisional application No. 63/552,878, filed on Feb. 13, 2024.

(51) Int. Cl. H02G 7/12

(52) U.S. Cl. CPC H02G 7/125

(57) ABSTRACT

A clamp for a utility line spacer includes a first jaw having a first clamping surface, a first aperture, and upper slot extending from the first aperture. A second jaw having a second clamping surface and an open-ended second aperture is connected to the first jaw. A first bushing is engaged with the first clamping surface of the first jaw. A second bushing is engaged with the second clamping surface of the second jaw. A fastener secures the first jaw relative to the first jaw. The first aperture is configured to receive the fastener in a first position and the upper slot is configured to permit rotation of the fastener relative to the first aperture to a second position.

### RELATED APPLICATION(S)

This application is based on U.S. Provisional Application Ser. No. 63/552,878, filed Feb. 13, 2024, the disclosure of which is incorporated herein by reference in its entirety and to which priority is claimed.

### FIELD

Various exemplary embodiments relate to clamps for power transmission conductors.

### BACKGROUND

Utility lines are used to transmit power from a generating facility to a distribution point. Typically, high voltage conductor lines are bundled over long distances to efficiently and economically transfer power and must be spaced from one another to avoid damage.

Damage to individual conductors in bundled electrical transmission lines may be caused by the vibration and oscillation or galloping of the conductors. Such undesired motions may be induced by the wind, and may have longitudinal, transverse and vertical components. Suppression of these vibrations and oscillations requires a resilient connection between the conductors with all the conductors in a bundle being spaced from one another while allowing a limited amount of flexing to occur.

The motion of the conductors in a bundle may also be caused by electrical power surges, which cause the conductors in a bundle to be attracted toward the center thereof. For example, in a bundle of three conductors defining, in cross section, a triangle, a surge causes the conductors to be attracted to a point at the center of the triangle. Similarly, in a bundle of four conductors defining, in cross section, a quadrilateral, a surge causes the conductors to be attracted to a point at the center of the quadrilateral.

To avoid damage of the conductor lines, spacer-dampers can be used to ensure sufficient distance between conductors and to provide vibration dampening. Spacer-dampers are attached to the conductors at certain intervals along the transmission distance. Because the transmission distance is often long, a large number of spacer-dampers are typically needed.

An example of a spacer damper with hinged clamps is shown in U.S. Pat. No. 9,570,897, the disclosure of which is hereby incorporated by reference in its entirety.

### SUMMARY

In certain configurations, a clamp for a utility line spacer includes a first jaw having a first clamping surface, a first aperture, and upper slot extending from the first aperture. A second jaw having a second clamping surface and an open-ended second aperture is connected to the first jaw. A first bushing is engaged with the first clamping surface of the first jaw. A second bushing is engaged with the second clamping surface of the second jaw. A fastener secures the first jaw relative to the second jaw. The first aperture is configured to receive the fastener in a first position and the upper slot is configured to permit rotation of the fastener relative to the first aperture to a second position.

In certain configurations, a clamp for a utility line spacer includes a first jaw having a first clamping surface, a first aperture, and upper slot extending from the first aperture. A second jaw is connected to the first jaw. The second jaw has a second clamping surface and an open-ended second aperture. A plurality of first bushings are configured to be engaged with the first clamping surface of the first jaw. A plurality of second bushings are configured to be engaged with the second clamping surface of the second jaw. A fastener secures the first jaw relative to the second jaw. The plurality of first bushing and the plurality of second bushings are selectively engaged with the first and second jaws dependent on the size of a transmission line to be held within the jaws.

In certain configurations, A utility line spacer includes a frame having a first arm, a second arm, and a third arm. A first clamp extends from the frame. The first clamp includes a first jaw having a first clamping surface, a first aperture, and upper slot extending from the first aperture. A second jaw having a second clamping surface and an open-ended second aperture is connected to the first jaw. A first bushing is engaged with the first clamping surface of the first jaw. A second bushing is engaged with the second clamping surface of the second jaw. A fastener secures the first jaw relative to the second jaw. The first aperture is configured to receive the fastener in a first position and the upper slot is configured to permit rotation of the fastener relative to the first aperture to a second position.

Certain implementations are directed to a method of installing a clamp for a transmission line. A bushing is selected from a group of bushings based on the size of a transmission line to be clamped. The selected bushing is installed by engaging it with a jaw on a clamp. The clamp is engaged with a transmission line to secure the transmission line in the clamp. The group of bushings includes a plurality of bushings with each bushing configured to receive a different sized transmission line. The clamp is configured to receive each of the plurality of bushings.

### BRIEF DESCRIPTION OF THE DRAWINGS

The aspects and features of various exemplary embodiments will be more apparent from the description of those exemplary embodiments taken with reference to the accompanying drawings.

FIG. 1 is a perspective view of a transmission line spacer.

FIG. 2 is a front view of a clamp of the transmission line spacer.

FIG. 3 is a top view of the clamp of FIG. 2

FIG. 4 is a bottom view of the clamp of FIG. 2.

FIG. 5 is a bottom, perspective view of a first jaw of the clamp.

FIG. 6 is a bottom view of the first jaw of FIG. 5.

FIG. 7 is a top view of the first jaw of FIG. 5.

FIG. 8 is a sectional, perspective view of the jaw of FIG. 5.

FIG. 9 is a bottom perspective view of a second jaw of the clamp.

FIG. 10 is a top perspective view of the second jaw of FIG. 9.

FIG. 11 is a perspective view of a first and second bushing.

FIG. 12 is a sectional view of the clamp with the fastener in a first position.

FIG. 13 is a sectional view of the clamp with the fastener rotated to a second position.

FIG. 14 is a front view of a bushing configured for use with a small transmission line.

FIG. 15 is a front view of a bushing configured for use with a medium transmission line.

FIG. 16 is a front view of a bushing configured for use with a large transmission line

### DETAILED DESCRIPTION OF EXEMPLARY EMBODIMENTS

In certain configurations, cable spacers for utility transmission lines can include one or more clamp members and an arm or arms separating the clamp members. The arms can be rigid components and the clamps can include one or more resilient members to help damp the movement of the transmission lines. Different configurations can utilize two, three, four, or more clamp members.

One example of a spacer-damper includes a frame and a set of clamps. The frame can include a plurality of rigid arms. The arms can be formed as a unitary structure or may be separately formed and attached to one another. The arms can be metallic, for example an aluminum alloy, or made from any suitable composite material. A corner is formed at the connection of each arm and a clamp is positioned at each corner.

The clamps are pivotally connected with respect to the frame and extend radially outwardly therefrom. Each clamp includes an opening for receiving a conductor. The clamps can be connected to the frame in a variety of manners as would be understood by one of ordinary skill in the art. The position of the clamps, as well as the size and spacing of the arms, may vary dependent on the application. Other combinations, for example one arm and two clamps or four arms and four clamps, can be utilized to provide spacing and vibration damping for two, four, six, eight, or any number of individual conductors.

The clamps can include a first jaw and a second jaw pivotally connected to the first jaw. The second jaw is moveable with respect to the first jaw from an open position to a closed position. The first and second jaws can be held in the closed position by a mechanical fastener. Bushings can be positioned inside of the jaws to provide damping and prevent damage to the received conductor. The bushings can be made from an elastomeric material and have a high temperature resistance.

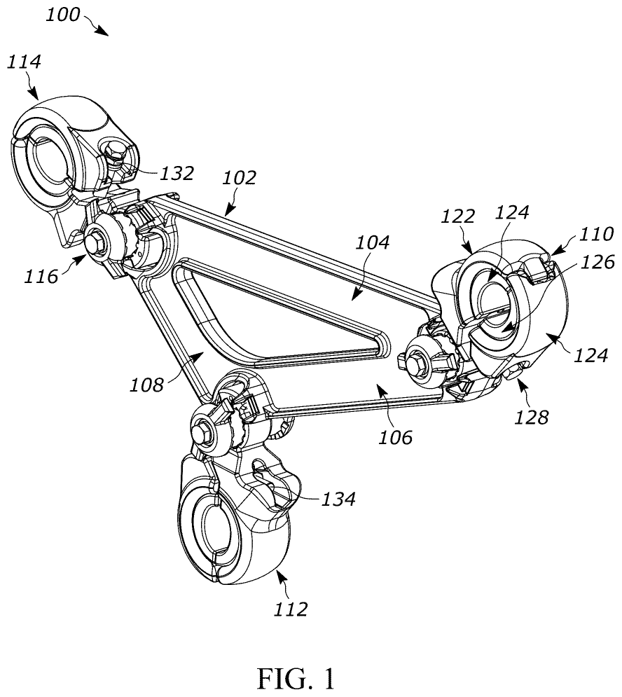

FIG. 1 shows an exemplary configuration of a spacer 100 having a frame 102 including a first arm 104, a second arm 106, and a third arm 108. A first clamp 110, a second clamp 112, and a third clamp 114 extend from the frame. The clamps 110, 112, 114 extend at intersection points between the respective arms 104, 106, 108. The clamps 110, 112, 114 can be rotatable relative to the frame 102 and can be secured in position by a frame fastener assembly 116. The frame fastener assembly 116 can include a rotatable cap and one or more bushings. Each clamp 110, 112, 114 can include a first jaw member 120 and a second jaw member 122. A first clamp bushing 124 can be engaged with the first jaw member 120 and a second clamp bushing 126 can be engaged with the second jaw member 122. The first and second bushings 124, 126 can at least partially define a receiving area for a transmission line, such as an electrical conductor. A clamp fastener 128 can be used to tighten the first jaw member 120 and the second jaw member 122 to secure a transmission line.

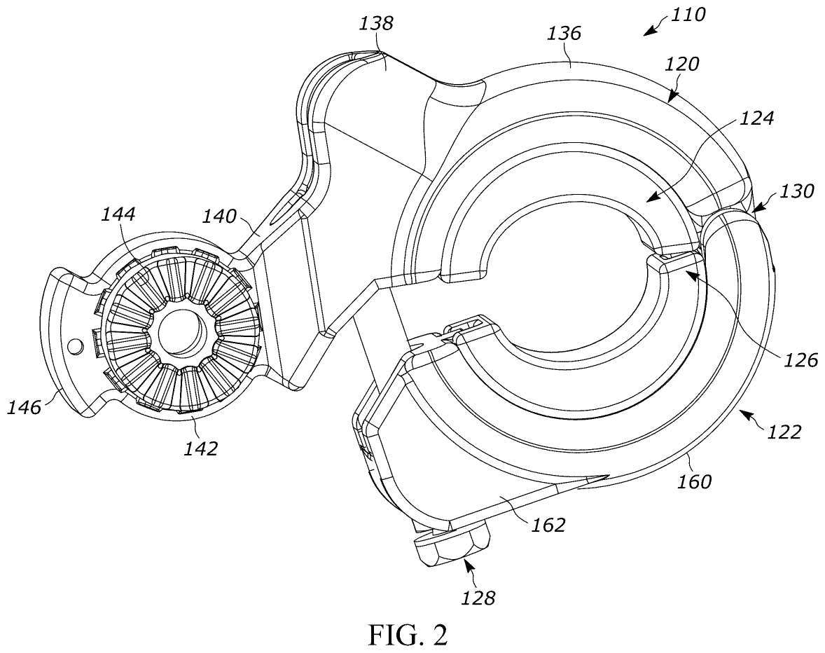

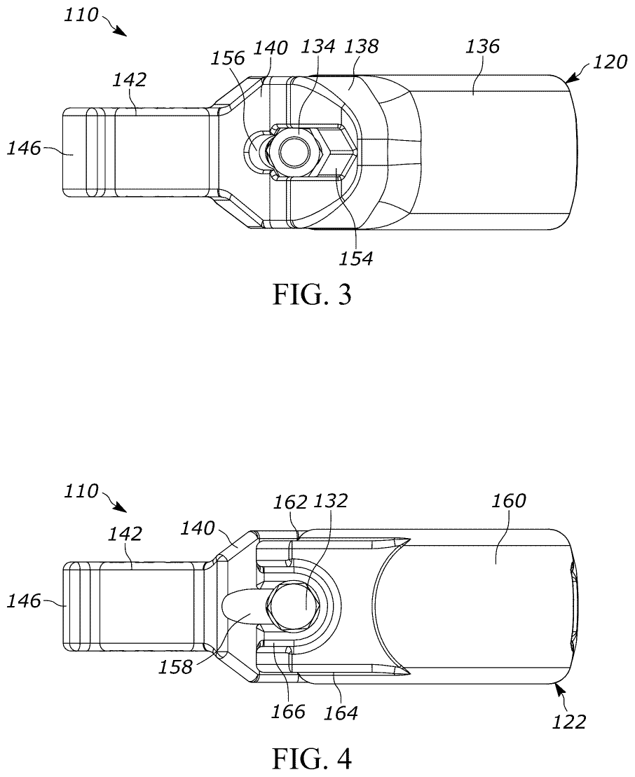

FIGS. 2-4 show an exemplary configuration of a clamp 110 having a first jaw 120 and a second jaw 122 pivotally connected to the first jaw 120. The second jaw 122 is moveable with respect to the first jaw 120 from an open position to a closed position. The jaws 120, 122 can be pivotally connected by a hinge connection 130 including a hinge pin, although other types of connections can be used. The first and second jaws 120, 122 can be held in the closed position by the clamp fastener 128 having a first portion and a second portion. In the exemplary embodiment shown, the first portion is a bolt 132 and the second portion is a nut 134, although any suitable mechanical fastener may be used. When the first and second jaws 120, 122 are in the closed position, the mechanical fastener 128 may be tightened to limit movement of the jaws 120, 122 with respect to one another.

The first jaw 120 has an arcuate first outer surface 136 and a ridge 138 extending from the first outer surface 136. The ridge 138 shelters the clamp fastener 128 and helps prevent or minimize corona discharge around the clamp 110. A leg 140 extends from the ridge 138 and connects to a journal member 142. The journal member 142 is substantially hollow-cylindrical in shape, having an opening for pivotally connecting to the frame 102. The journal member 142 includes a set of corrugations 144 or radially extending teeth allowing the journal member 142 to be locked in a series of set pivoted positions relative to the frame 102. An arcuate projection 146 extends outwardly from the journal member 142. The first jaw 120 may be a unitary structure or formed from multiple pieces.

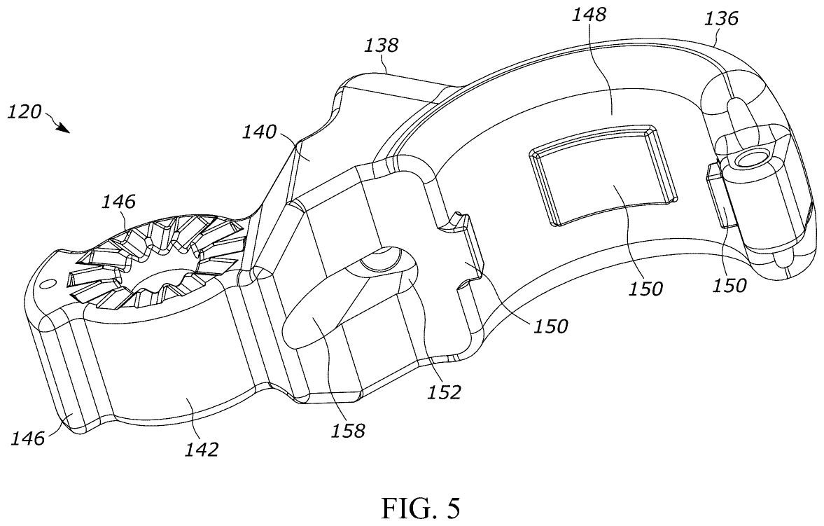

As best shown in FIG. 5, the first jaw 122 includes a first inner clamping surface 148. The first inner clamping surface 148 includes an arcuate surface designed to clamp a cylindrical line. Various alternative embodiments may utilize a non-round configuration, for example an elliptical or polygonal configuration, to clamp different shaped transmission lines. A set of protrusions 150 extend from the first inner clamping surface 148 to engage and retain the first bushing 124.

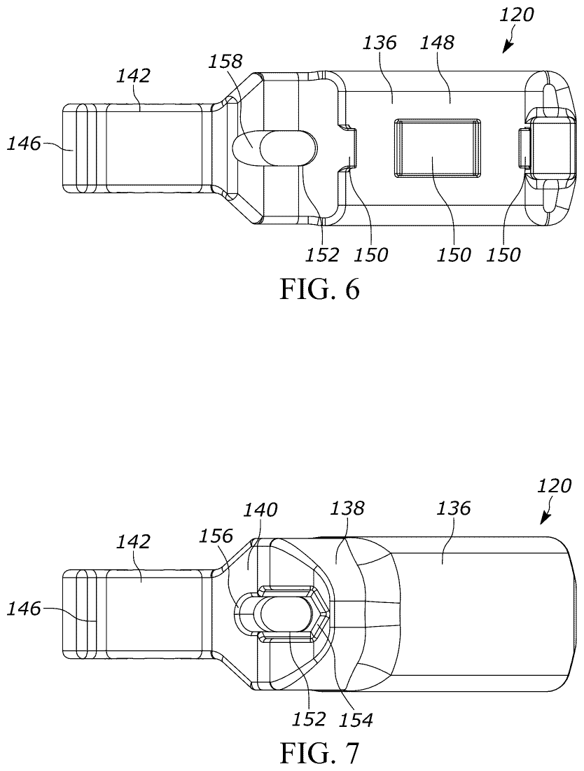

As best shown in FIGS. 5-7, a first aperture 152 extends through the first jaw. The first aperture 152 can be a substantially obround or oblong opening that extends through at least a portion of the leg 140. The first aperture 152 can extend in an axial direction relative to the fastener 128 and can include a first axis A1 that extends substantially orthogonal to a clamped line. In alternative embodiments, the position, size, and shape of the first aperture 152 may vary. The obround opening retains the mechanical fastener 128 allowing it to be moved laterally during installation.

In certain configurations, a keeper pocket 154 can be formed in the ridge 138 positioned in front of the first aperture 152. The keeper pocket 154 can include one or more sides that are configured to engage the clamp fastener 128. For example, the illustrated embodiment shows an angled first side and an angled second side configured to receive a hex nut 134 from the fastener 128. The pocket 158 engages the nut 134 to prevent or limit rotation of the nut with respect to the bolt 132.

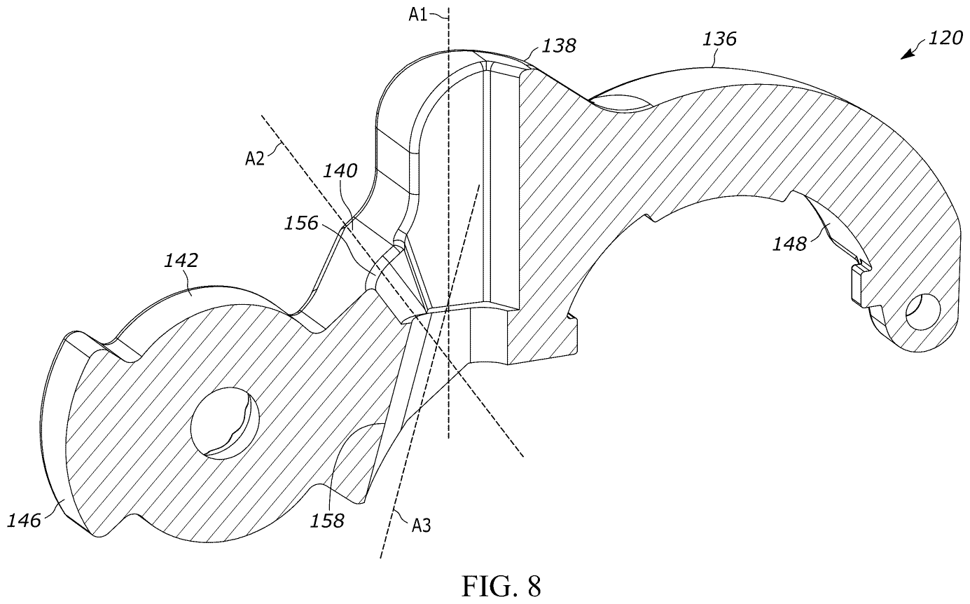

In certain configurations, an upper slot 156 extends from the first aperture 152 at an oblique angle as best shown in FIG. 8. The upper slot 156 can include an arcuate inner wall that is offset from the first aperture 152. The upper slot 156 extends along a second axis A2 that intersects the first axis A1. The upper slot 156 extends away from first aperture 152 toward the journal member 142.

In certain configurations, a lower slot 158 extends from the first aperture 152 at an oblique angle as best shown in FIG. 8. The lower slot 158 can include an arcuate inner wall that is offset from the first aperture 152. The lower slot 158 extends along a third axis A3 that intersects the first axis A1 and the second axis A2. The lower slot 158 extends away from first aperture 152 toward the journal member 142.

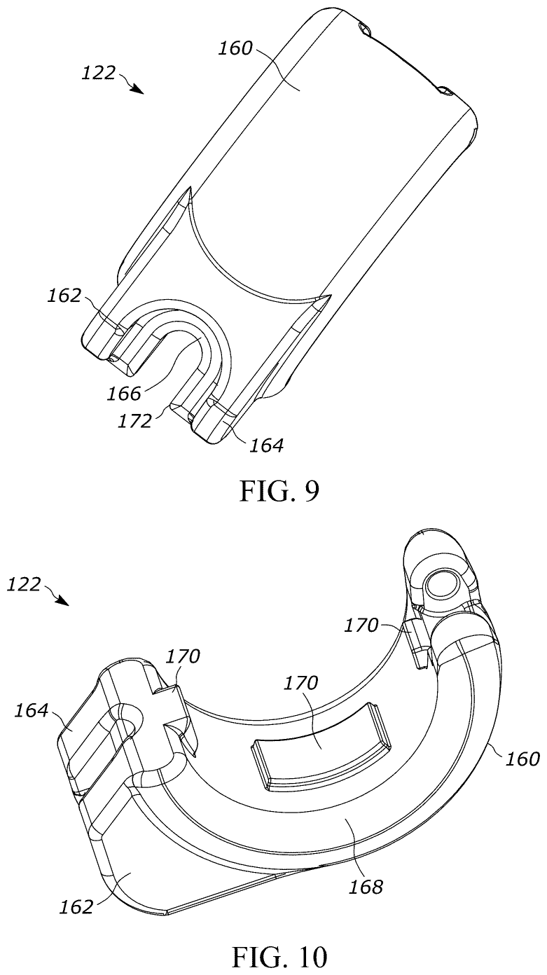

As best shown in FIGS. 9 and 10, the second jaw 122 can include an arcuate second outer surface 160. A first extension 162 and a second extension 164 extend from the second outer surface 160. A ledge 166 extends from the second outer surface 160 positioned at least partially between the first and second extensions 162, 164. The first and second extensions 162, 164 shelter the clamp fastener 128 and help prevent or minimize corona discharge around the clamp 110. The second jaw 122 may be a unitary structure or formed from multiple pieces.

The second jaw 122 includes a second inner clamping surface 168 having an arcuate surface designed to clamp a cylindrical transmission line. Various alternative embodiments may utilize a non-round configuration, for example, an elliptical or polygonal configuration, to clamp different shaped lines. A set of protrusions 170 extend from the second inner clamping surface 168 to engage and retain the second bushing 126.

A second aperture 172 extends through the second jaw 122. The second aperture 172 is formed in the ledge 166 and is a U-shaped slot having an open end remote from the second inner clamping surface 168. In various alternative embodiments, the size, shape, and position of the second aperture 172 may vary. As the clamp fastener 128 is tightened, a portion of the fastener 128, for example a head or one or more washers associated with the head, contacts the ledge 166 to hold the second jaw 122 in a closed position.

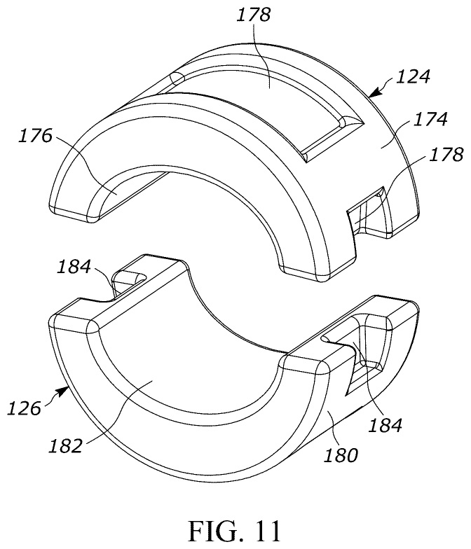

As best shown in FIG. 11, the first bushing 124 has an outer surface 174 contacting the first jaw 120 and an inner surface 176 for contacting a transmission line. In the illustrated configuration, the outer surface 174 has a circular profile and the inner surface 176 has a non-circular profile. The first bushing 124 can also include depressions 178 to mate with the protrusions 150 on the first jaw 120. The first bushing 124 provides damping and prevents damage to the transmission line and the clamp 110 during use. The first bushing 124 may be made from an elastomeric material and have a high temperature resistance.

The second bushing 126 has an outer surface 180 contacting the second jaw 122 and an inner surface 182 for contacting a transmission line. In the illustrated configuration, the outer surface 180 has a circular profile and the inner surface 182 has a non-circular profile. The second bushing 126 provides damping and prevents damage to the transmission line and the clamp 110 during use. The second bushing 126 can also include depressions 184 to mate with the protrusions 170 on the second jaw 122. The second bushing 126 may be made from an elastomeric material and have a high temperature resistance.

In prior implementations, different clamps and different bushings were needed for clamping different sizes and types of transmission lines. This requires a large number of clamps and bushings to be produced and held in inventory by a supplier and end user. To overcome this deficiency, the present clamps have been designed to accommodate a large range of bushings so that the same clamp can be used with different sized transmission lines.

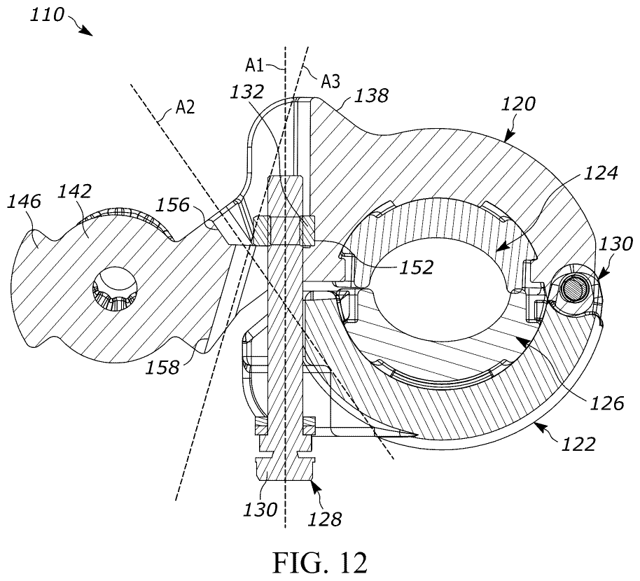

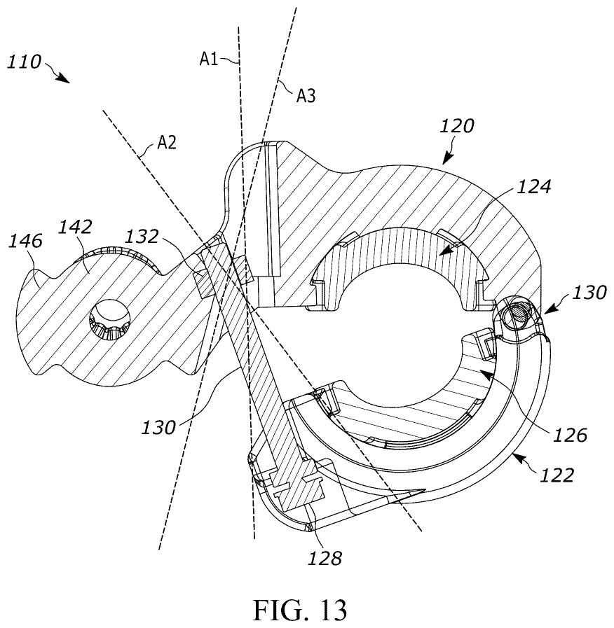

In certain implementations, the upper slot 156 and the lower slot 158 provide space for the bolt 132 to be oriented at an angle relative to the axis A1 of the first aperture 152, while still retaining the clamp 110 in a closed position around a transmission line. For example, as shown in FIGS. 12 and 13, when clamping a first transmission line having a first diameter, or a set of transmission lines having a first range of diameters, the bolt 132 of the fastener 128 will be oriented substantially parallel with the first axis A1. When clamping a second transmission line having a second diameter, or a set of transmission lines having a second range of diameters, the bolt 132 of the fastener 128 will be oriented at an oblique angle to the first axis A1. The fastener 128 can extend into the upper and lower slots 156, 158 so that a larger diameter of conductor can be retained using the same clamp 110.

The bushings 124, 126 can be swapped in the clamps as needed to provide a secure fit based on the size of the transmission line. The configuration of the bushings can also help to accommodate different sized transmission lines. For example, the interior clamping surface of the bushings has a non-circular profile that can assist in allowing a larger range of transmission lines to be accommodated than with a circular inner profile.

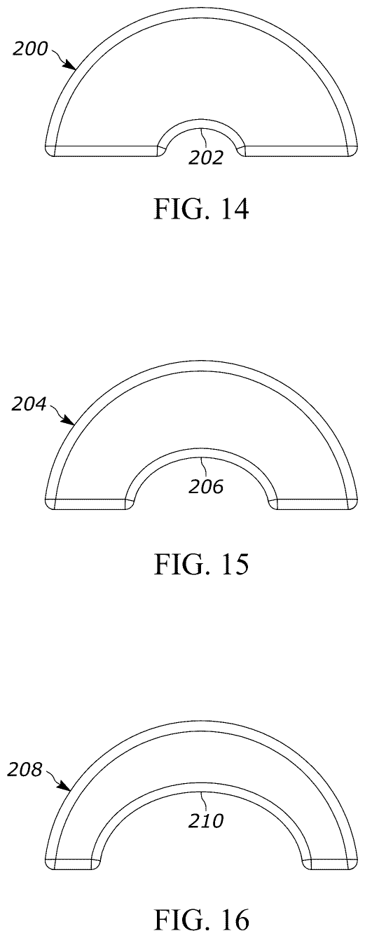

In certain implementations, the clamps are configured to accommodate a large range of bushings and line sizes. In certain examples, thirty or more different bushings can be used with the clamps 110, 112, 114 without any modification to the clamps or bushings. FIGS. 14-16, show examples of different sized bushing that can be used. FIG. 14 shows an example of a bushing 200 having an inner clamping surface 202 designed for a smaller sized transmission line. FIG. 15 shows an example of a bushing 204 having an inner clamping surface 206 designed for a medium sized transmission line. FIG. 16 shows an example of a bushing 208 having an inner clamping surface 210 designed for a smaller sized transmission line. Different sizes, smaller, larger, and between what is shown can be used with the clamp 110.

The foregoing detailed description of the certain exemplary configurations and implementations has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings.

What is claimed:

1. A clamp for a utility line spacer comprising:
a first jaw having a first clamping surface, a first aperture, and upper slot extending from the first aperture;
a second jaw connected to the first jaw, the second jaw having a second clamping surface and an open-ended second aperture;
a first bushing engaged with the first clamping surface of the first jaw;
a second bushing engaged with the second clamping surface of the second jaw; and
a fastener for securing the first jaw relative to the first jaw,
wherein the first aperture is configured to receive the fastener in a first position and the upper slot is configured to permit rotation of the fastener relative to the first aperture to a second position.

2. The clamp of claim 1, wherein the fastener includes a bolt and a nut.

3. The clamp of claim 2, wherein the first jaw includes a keeper pocket configured to receive the nut.

4. The clamp of claim 1, wherein the first jaw comprises an inner hinge member and the second jaw comprises an outer hinge member and the outer hinge member is pivotally connected to the inner hinge member by a pin.

5. The clamp of claim 1, wherein the first aperture extends along a first axis and the upper slot extends along a second axis non-parallel to the first axis.

6. The clamp of claim 1, wherein the first jaw includes a lower slot extending from the first aperture.

7. The clamp of claim 1, wherein the first jaw and the second jaw are configured to receive a plurality of different sized bushings.

8. The clamp of claim 1, wherein the first bushing has a non-circular first inner surface and the second bushing has a non-circular second inner surface.

9. The clamp of claim 1 wherein the first jaw includes a ridge extending from the first aperture.

10. A clamp for a utility line spacer comprising:
a first jaw having a first clamping surface, a first aperture, and upper slot extending from the first aperture;
a second jaw connected to the first jaw, the second jaw having a second clamping surface and an open-ended second aperture;
a plurality of first bushings configured to be engaged with the first clamping surface of the first jaw;
a plurality of second bushings configured to be engaged with the second clamping surface of the second jaw; and
a fastener for securing the first jaw relative to the first jaw,
wherein the plurality of first bushing and the plurality of second bushings are selectively engaged with the first and second jaws dependent on the size of a transmission line to be held within the jaws.

11. The clamp of claim 10, wherein the first aperture is configured to receive the fastener in a first position to clamp a transmission line having a first diameter and the upper slot is configured to permit rotation of the fastener relative to the first aperture to a second position to clamp a transmission line having a second diameter larger than the first diameter.

12. The clamp of claim 10, wherein each of the plurality of first bushing include an inner surface configured to receive a different-sized transmission line.

13. The clamp of claim 12, wherein the inner surfaces are non-circular.

14. The clamp of claim 10, wherein the first aperture extends along a first axis and the upper slot extends along a second axis non-parallel to the first axis.

15. The utility line spacer of claim 14, wherein the first jaw includes a lower slot extending from the first aperture.

16. The clamp of claim 15, wherein the first jaw includes a lower slot extending from the first aperture, wherein the lower slot extends along a third axis non-parallel to the first axis and the second axis.

17. The clamp of claim 10, wherein the plurality of first bushings include a small bushing having a first non-round engagement surface with a first area and a large bushing having a second non-round engagement surface with a second area greater than the first area.

18. A method of installing a clamp for a transmission line comprising:
selecting a bushing from a group of bushings based on the size of a transmission line to be clamped;
installing the selected bushing by engaging it with a jaw on a clamp;
engaging the clamp with a transmission line to secure the transmission line in the clamp,
wherein the group of bushings includes a plurality of bushings with each bushing configured to receive a different sized transmission line, and
wherein the clamp is configured to receive each of the plurality of bushings.

19. The method of claim 18, wherein the clamp includes a first jaw receiving the bushing and a second jaw, wherein engaging the clamp with the transmission line includes securing the first jaw relative to the second jaw with a fastener, and wherein the angle of the fastener relative to the first jaw when the transmission line is secured is dependent on the selected bushing.

20. The method of claim 18, wherein the group of bushings include a first bushing having a first non-round engagement surface with a first area and a second bushing having a second non-round engagement surface with a second area greater than the first area.
